(19) United States
(12) Patent Application Publication
(10) Pub. No.: US 2009/0230685 A1
(43) Pub. Date: Sep. 17, 2009

(54) SYSTEM AND METHOD FOR CONVERTING FLUID PRESSURE INTO ELECTRIC ENERGY

(76) Inventor: EVERETT L. MCCALL, Spanway, WA (US)

Correspondence Address: James Ray & Associates, 2640 Pitcairn Road, Monroeville, PA, 15146, US

(21) Appl. No.: 12/400,826

(22) Filed: Mar. 10, 2009

Related U.S. Application Data
(60) Provisional application No. 61/035,454, filed on Mar. 11, 2008.

(51) Int. Cl. F03B 13/06; F03B 17/04

(52) U.S. Cl. 290/54; 415/916

(57) ABSTRACT

A system for converting fluid pressure into electric energy includes a pair of storage tanks each having a fluid stored under pressure in a lower chamber, an air stored under pressure in an upper chamber, and a flexible diaphragm for separating the chambers. An air valve is connected to the upper chamber. A flow direction control is connected to each first chamber. A conduit connects the outlet port of the flow direction control valve to one of its three input ports. A flow rate control valve is interposed in series with the flow direction control valve. At least one electric generator is operable by the first fluid under pressure to generate electric energy. A reservoir and a fluid pump are also interposed within the conduit. A controller and battery are electrically connected to each of the pump, the flow rate control valve and the flow direction control valve.

### CROSS-REFERENCE TO RELATED APPLICATIONS

This application is related to and claims priority from Provisional Patent Application Ser. No. 61/035,454 filed on Mar. 11, 2008.

### FIELD OF THE INVENTION

The present invention relates, in general, to electric generators and, more particularly, this invention relates to a system for a vehicle or dwelling that converts fluid flow pressure into electric energy.

### BACKGROUND OF THE INVENTION

As is generally well known, due to costs and environmental effects of burning fossil fuels, various alternative systems have been used to generate electric energy. Significant technical advances have been achieved in the area of using electric energy to power an automobile. Subsequently, efforts have been made to harvest wind power, either as a primary or secondary source, in order to generate electric energy. Prior to the conception and development of the present invention, efforts have been also made to use fluid pressure to generate electric energy for automobiles. U.S. Pat. No. 3,379,008 issued to Manganaro, U.S. Pat. No. 6,054,838 issued to Tsatsis, U.S. Pat. No. 6,748,737 issued to Lafferty, U.S. Pat. No. 6,815,840 issued to Aldendeshe and U.S. Pub. 2008/0083222 disclose various systems for converting fluid pressure into electric energy.

While these prior art systems eliminate or significantly reduce burning of fossil fuels, there is a continuing need for improved systems capable of generating electrify by converting fluid pressure.

### SUMMARY OF THE INVENTION

The invention provides a system for converting fluid pressure into electric energy. The system includes at least one storage tank having each of a flexible diaphragm attached to an inner surface thereof and forming each of a first and second sealed chamber, a first fluid stored under a first pressure in the first chamber, a second fluid stored under a second pressure in the second chamber, a first port for at least dispensing the first fluid under pressure from the second fluid, a second port for filling the second chamber with the second fluid and a third port for returning the first fluid into the first chamber. A valve is secured to the at least one storage tank in operable alignment with the second port thereof. A conduit connects the first port of the at least one storage tank to the third port thereof. A flow rate control valve is interposed within the conduit in series with the first port. The flow rate control valve is operable to modulate flow of the first fluid in proportion to received input current. At least one electric generator is interposed within the conduit and operable by the first fluid under pressure to generate electric energy. A reservoir is additionally interposed within the conduit in series with the at least one electric generator. A fluid pump is finally interposed within the conduit mediate the reservoir and the third port of the at least one storage tank.

The present invention also provides a system for converting fluid pressure into electric energy. The system includes a pair of storage tanks. Each of the pair of storage tanks includes each of a flexible diaphragm attached to an inner surface thereof and forming each of a first and second sealed chamber, a first fluid stored under a first pressure in the first chamber, a second fluid stored under a second pressure in the second chamber, a first port for at least dispensing the first fluid under pressure from the second fluid, and a second port for filling the second chamber with the second fluid. There is a pair of valves, each of the pair of valves secured to a respective storage tank in operable alignment with the second port thereof. A flow direction control valve is provided and has each of a first inlet port connected to one of the pair of storage tanks, a second inlet port connected to an opposed one of the pair of storage tanks, a third inlet port and an outlet port. A conduit connects the outlet port of the flow direction control valve to the third inlet port thereof. A flow rate control valve is interposed within the conduit in series with the flow direction control valve and operable to modulate flow of the first fluid in proportion to received input current. At least one electric generator is interposed within the conduit and operable by the first fluid under pressure to generate electric energy. A reservoir is interposed within the conduit in series with the at least one electric generator. A fluid pump is interposed within the conduit mediate the reservoir and the third inlet port of the flow direction control valve. A controller is electrically connected to each of the pump, the flow rate control valve and the flow direction control valve. A battery is also provided.

The present invention finally provides a method of converting fluid pressure into electric energy. The method includes the step of providing a storage tank having each of a flexible diaphragm attached to an inner surface of the storage tank for dividing the at least one storage tank into each of a first and second sealed chamber, a first port in communication with the first chamber and a second port in communication with the second chamber. Then, filling the second chamber with air to a first predetermined pressure. Next, filling the first chamber with fluid to a second predetermined pressure. Connecting, in fluid communication, an electrically operable flow rate control valve to the first port. Then, connecting, in the fluid communication, at least one electric generator to the electrically operable flow rate control valve. Next, connecting, in the fluid communication, a reservoir to the at least one electric generator. Connecting, in the fluid communication, a fluid pump to the reservoir. Then, connecting, in the fluid communication, the fluid pump to the storage tank. Next, dispensing the first fluid under pressure from the first chamber. Converting, at the at least one electric generator, mechanical energy from the first fluid under pressure into the electric energy. Then, temporarily storing the first fluid in the reservoir. Finally, activating the pump to return the first fluid into the first chamber.

### OBJECTS OF THE INVENTION

It is, therefore, one of the primary objects of the present invention to provide a system for converting fluid flow pressure into electric energy.

Another object of the present invention is to provide a system for converting fluid flow pressure into electric energy that employs a pair of prepressurized storage tanks.

Yet another object of the present invention is to provide a system for converting fluid flow pressure into electric energy that is economical to manufacture.

A further object of the present invention is to provide a system for converting fluid flow pressure into electric energy that is simple to use.

Yet a further object of the present invention is to provide a system for converting fluid flow pressure into electric energy that is capable of supplying generally uninterrupted flow of fluid pressure.

An additional object of the present invention is to provide a system for converting fluid flow pressure into electric energy that employs a microprocessor based controller.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 shows a block diagram of a fluid circuit employed by an electric energy generating system constructed according to one embodiment of the present invention;

FIGS. 2a-2b show block diagrams of a fluid circuit employed by an electric energy generating system constructed according to a presently preferred embodiment of the present invention;

FIG. 3 shows a block diagram of a storage tank employed in the electric energy generating system of FIG. 1 or FIG. 2;

FIG. 4 shows a block diagram of an electric circuit of the electric energy generating system of FIG. 1 or FIG. 2;

FIG. 5 illustrates isometric view of the electric energy generating system or FIG. 2;

FIG. 6 illustrates environmental view of using the system of FIG. 2 for generating electric energy for a vehicle;

FIG. 7 is a partial block diagram of the system of FIG. 1 or 2, particularly illustrating employment of plurality of electric generator arranged in series with each other; and

FIG. 8 is a partial block diagram of the system of FIG. 1 or 2, particularly illustrating employment of plurality of electric generator arranged both in series and parallel with each other.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of a fluid applies to both liquid and gas.

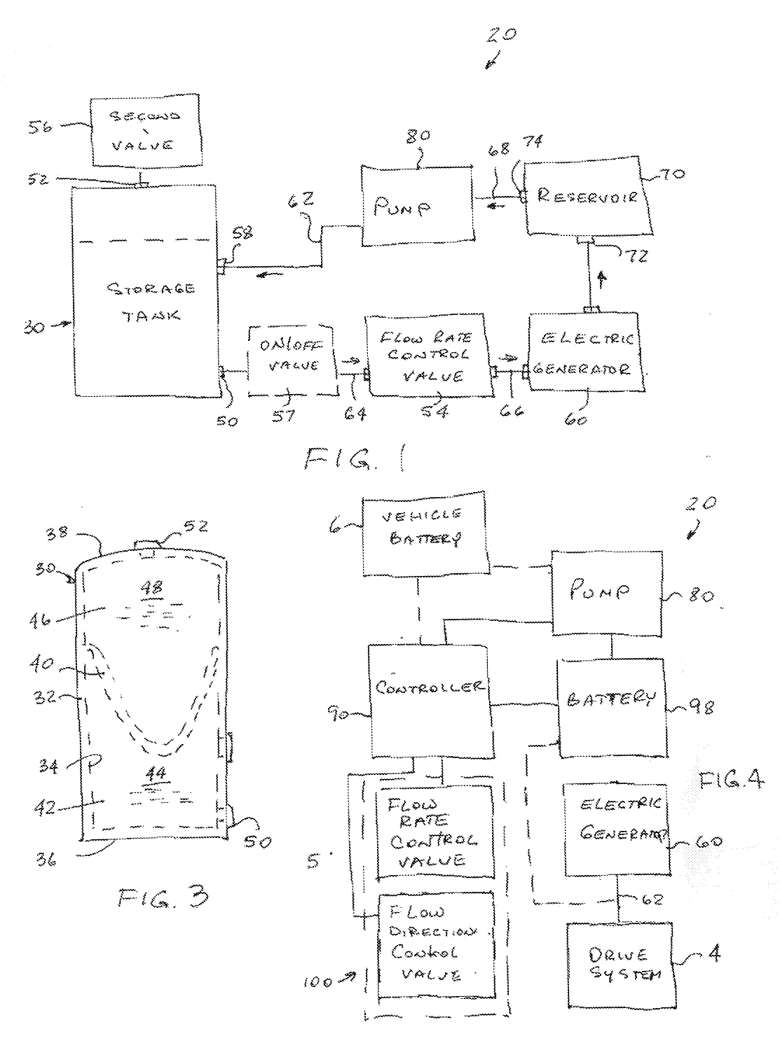

The best mode for carrying out the invention is presented in terms of its embodiments, herein depicted within FIGS. 1 through 8. However, the invention is not limited to the described embodiments, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only two particular configurations shall be shown and described for purposes of clarity and disclosure and not by way of limitation of scope.

Now in a particular reference to FIGS. 1, 3-4, therein is illustrated a system, generally designated as 20, for generating electric power by converting fluid flow under pressure and which is constructed in accordance with one embodiment of the invention.

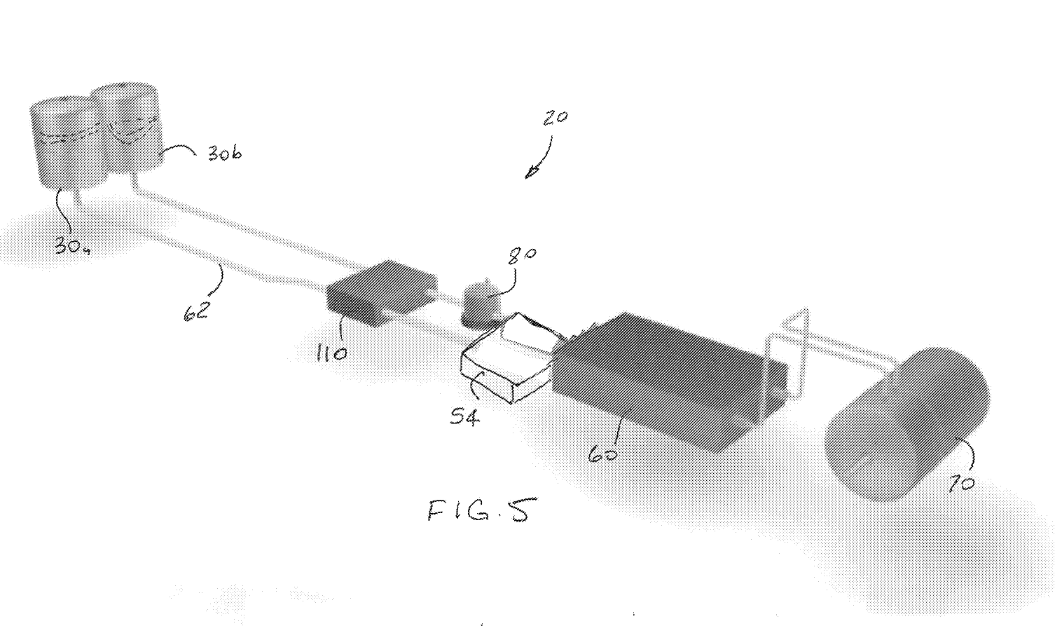

The system 20 includes a storage tank, generally designated as 30 and best shown in FIG. 3. The storage tank 30, essentially being a hollow pressure vessel, is defined by a peripheral side wall 32 having an inner surface 34 and a pair of ends 36, 38 closing the side wall 32 and forming a pressure tight storage tank 30. A flexible diaphragm 40 is attached at a peripheral edge thereof to the inner surface 34 of the side wall 32. The flexible diaphragm 40 divides the storage tank 30 into a first chamber 42 for storing a first fluid 44 to be dispensed and a second chamber 46 for storing a second fluid 48 under pressure. It is presently preferred for the first fluid 44 to be a conventional hydraulic fluid, for example of the type employed in automotive brake systems, while providing the second fluid 48 as air.

In the present invention, the storage tank 30 is mounted upright with the first chamber 42 disposed at the bottom of the storage tank 30 adjacent the first end 36 while the second chamber 46 is disposed above the first chamber 42 adjacent the second end 38.

A first port 50 is provided in open communication with the first chamber 42 for at least one of filling the first chamber 42 with the first fluid 44 and dispensing the first fluid 44 therefrom. A second port 52 is provided in open communication with the second chamber 46 for filling such second chamber 46 with the second fluid 48 under pressure. Thus, the second chamber 46 of the storage tank 30 is prepressurized prior to its use for generating electric energy.

The storage tank 30 may be constructed in accordance with FIGS. 1-4 of the U.S. Pat. No. 7,032,628 issued to Guillemette at al. whose teachings are incorporated into this document by reference thereto. However, it is not necessary for the first port 50 to be disposed in the center of the first end 36 of the storage tank 30 as the present invention provides for a minimum volume of the first fluid 44 to remain in the first chamber 42 at all times. It is actually preferred to dispose the first port 50 in the side wall 32 in close proximity to the first end 36 so as to eliminate the need to elevate the bottom end 36 above the surface that the storage tank 30 to be supported on, thus simplifying the construction of the storage tank 30 and subsequently reducing its manufacturing costs.

A first valve 54 is secured to the storage tank 30 in operable alignment with the first port 50 thereof. Preferably, the first valve 54 is provided as an electrically operated proportional flow control valve 54 that modulates fluid flow in proportion to the input current it receives. An optional manually operable ON/OFF valve 57 may be also provided being interposed between the first port 50 and the proportional flow control valve 54.

An air valve 56 is secured to the storage tank 30 in operable alignment with the second port 52 thereof. The air valve 56 may be of any conventional type enabling filling the second chamber 46 with pressurized air and refilling as necessary if the leakage develops during use. Prepressurizing the second chamber 46 with air pressure of about 1,000 pounds per square inch (PSI) has been found desirable for use in the present invention for generating electric energy on most vehicles 2.

The system 20 also includes an electric generator 60 capable of converting mechanical energy from the flow of first fluid 44 under pressure from the first chamber 42 into electric energy. The electric generator 60 has a connection 62 for routing generated electric energy to a drive system 4 of the vehicle 2. Any conventional fluid pressure driven electric generator is contemplated for use in the present invention. By way of one example only, the electric generator 60 may be of the type disclosed in U.S. Pat. No. 6,011,334 issued to Roland, whose teachings are incorporated into this document by reference thereto. The specific size of the electric generator 60 will generally depend on the amount of electric energy to be generated and physical confines of a specific application. The prior art electric generator disclosed in U.S. Pat. No. 6,011,334 may be advantageous for mounting underneath the floor portion of a conventional automobile due to its in-line construction and generally reduced radial circumference.

In order to mount the electric generator 60, a conduit 62 is provided and has one portion 64 thereof coupled at a respective end thereof in fluid communication to each of the outlet port of the proportional flow control valve 54 and the inlet port of the electric generator 60. Another portion 66 of the conduit 62 is coupled at a respective end thereof in fluid communication to each of the outlet port of the electric generator 60 and the inlet port 72 of a reservoir 70 which is provided to collect the first fluid 44 dispensed from the storage tank 30 and passed through the electric generator 60. Thus the electric generator 60 is interposed into the conduit 62.

Yet another portion 68 of the conduit 62 connects the outlet port 74 of the reservoir 70 with a third port 58 of the storage tank 30 for enabling the dispensed first fluid 44 to return into the first chamber 42. An electrically operable pump 80 is also interposed into the conduit 62 and is provided to extract the first fluid 44 from the reservoir 70 and return it under increased pressure into the first chamber 42. Again, any conventional fluid pump 80 may be employed. A controller 90, preferably of a microprocessor type, is coupled to the pump 80 and energizes the pump 80 upon receipt of a control signal. Discontinuation of this control signal or receipt of another control signal causes the controller 90 to deenergize the pump and discontinue flow of the first fluid 44 into the first chamber 42. Since return of the first fluid 44 into the first chamber 42 generally prevents generation of the electric power and since efficiency is lost during conversion of the fluid pressure into electrical energy, the system 20 and, more particularly, the controller 90 and the pump 80 are coupled to a source of electric power, such as a battery 6 of the vehicle 2. Alternatively or in combination with the vehicle battery 6, a battery 98 can be interposed into the system 20 of the present invention. In operation, the battery 98 provides auxiliary electric power to the system 20 and may be employed to start operation of the system 20. The battery 98 may be coupled to the drive system 4 of the vehicle 2 or may be coupled to the connection 62 on the electric generator 60 in order to be recharged thereby through conventional recharging devices (not shown).

In operation, the second chamber 46 is prepressurized with air 48 to about 1,000 PSI through the air valve 56. Then, the first chamber 42 is filled with the hydraulic fluid 44 through the first port 50 further increasing the pressure of the air in the second chamber 46 to about 3,000 PSI. When the system 20 is activated, preferably through the controller 90, the hydraulic fluid 44 is dispensed from the first chamber 42 by the pressure from air 48 and passes through the electric generator 60 that converts the mechanical energy from the fluid pressure into electric energy. The hydraulic fluid 44 passed through the electric generator 60 flows into the reservoir 70. As the hydraulic fluid 44 flows out from the first chamber 42, the flexible diaphragm 40 moves downwardly and the air pressure decreases. The flow of the hydraulic fluid 44 from the first chamber 42 terminates when the flexible diaphragm 40 is in its most downward position and when the air pressure reaches the initial value of about 1,000 PSI. When the flow of hydraulic fluid 44 from the first chamber 42 is terminated, the hydraulic fluid 44 is returned from the reservoir 70 to the first chamber 42 through the by the pump 80.

The controller 90 may receive the control signal from the drive system 4 or the ignition system (not shown) of the vehicle 2. The flow rate of the first fluid 44 is controlled by the controller 90 through the proportional flow control valve 54 based on the amount of electric energy to be generated.

In order to at least minimize interruption of electric energy generation, the system, generally designated as 100, is provided in accordance with a presently preferred embodiment of the invention. The system 100 is constructed according to the principles of above described system 20, except that the system 100 includes a pair of storage tanks 30 and an electrically controlled flow direction control valve 110.

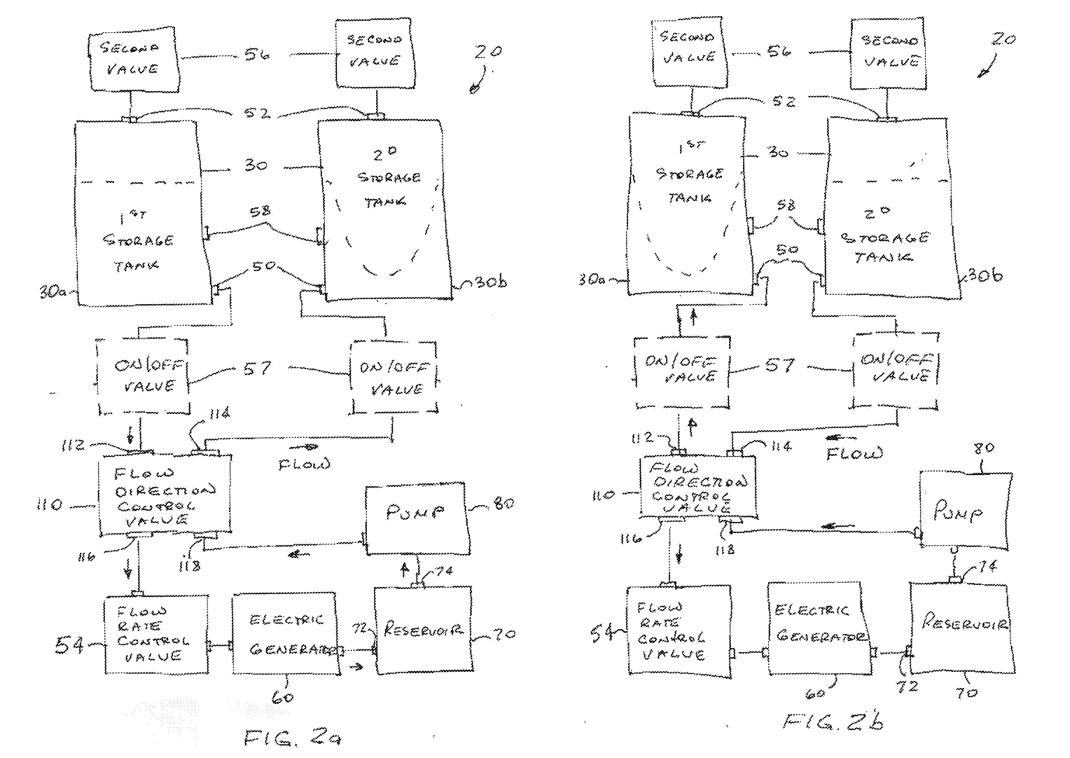

Now, in reference to FIGS. 2-6, the pair of tanks 30 are usually juxtaposed with each other. The flow direction control valve 110 has each of a first inlet port 112 connected in fluid communication to each of the first ports 50, a second inlet port 114 connected in fluid communication to the flow rate control valve 54, a third inlet port 116 and an outlet port 118. The third inlet port 116 is connected in fluid communication to the outlet of the pump 80 and the outlet port 118 is connected in fluid communication to the inlet port of the electric generator 60. The flow direction control valve 110 also has an electrical connection with the controller 90 and electrical connection with the battery 98.

Prior to operation, one of the storage tanks 30, referenced with numeral 30a and shown to the left of FIGS. 2a and 2b, receives the entire amount of first fluid 44, while the opposed tank 30, referenced with numeral 30b, receives only the amount of first fluid 44 generally equal to the amount of first fluid 44 remaining in the first chamber 42 at all times. Each storage tank 30 receives the first fluid 44 after the second chamber 46 is pressurized.

In operation, the first fluid 44 is dispensed from the storage tank 30a at a controlled rate from the fully filled first chamber 42 and is routed through the flow direction control valve 110 to the electric generator 60. The first fluid 44 exiting the electric generator 60 flows into the reservoir 70 and is pumped by the pump 80 to the second storage tank 30b increasing pressure of the second fluid 48 in the second storage tank 30b to about 3,000 PSI. This process continues until the predetermined volume of the first fluid 44 is dispensed from the first storage tank 30a. Then, the controller 90 reverses flow of the first fluid 44 wherein the first fluid 44 flows out from the second storage tank 30b and is returned to the first storage tank 30a. This alternating flow of the first fluid 44 provides for substantially uninterrupted generation of the electric energy by the electric generator 60. Again, due to efficiency losses, battery 98 is employed in the system 100. The third port 58 is not required in the system 100 and may be permanently capped or eliminated.

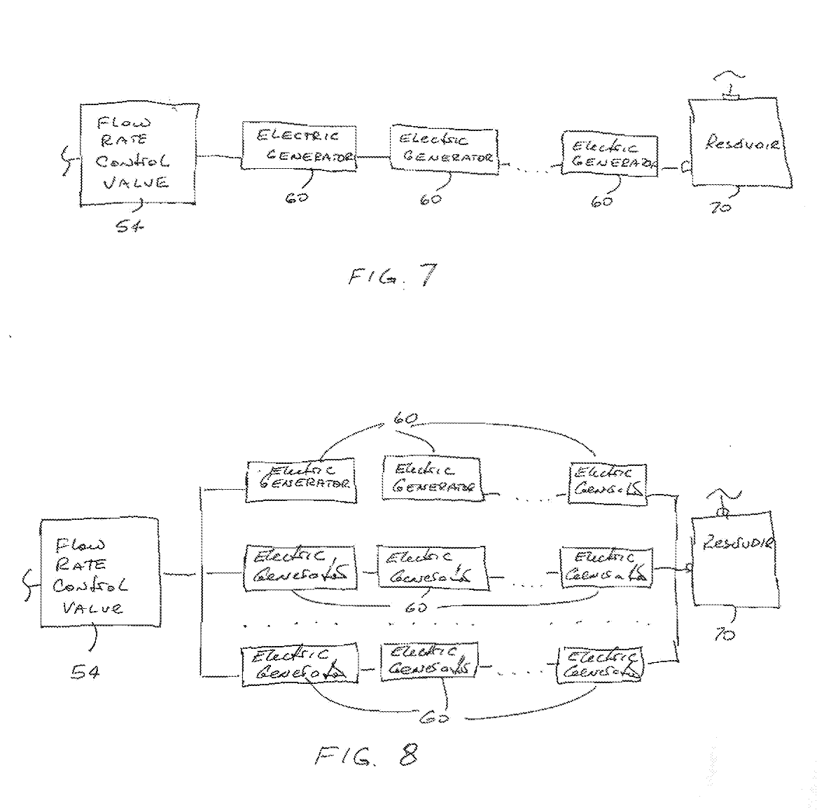

It is also within the scope of the present invention, in order to minimize height of the system 20 or 100, to provide a plurality of electric generators 60 connected in series with each other, as best shown in FIG. 7, as well as to provide plurality of branches connected parallel to each other relative to the flow of the first fluid 44, each of the branches having at least one and, preferably a predetermined plurality of electric generators 60 connected in series with each other, as best shown in FIG. 8.

The quantity of electric generators 60 is determined based on the flow of the first fluid 44, amount of electric energy to be generated and further based on utilization of the usable pressure range of the first fluid 44 which is, in the above example, is about 2,000 PSI.

In further reference to FIG. 6, therein is shown one example of installation of the system 100 on the vehicle 2, wherein the storage tanks 30 are mounted in the rear storage compartment 8 while the remaining components are generally mounted under the floor area. However, it would be understood that the entire system 100 may be mounted within the rear storage compartment 8 or in any other locations a dictated by the design of the vehicle 2.

It has also been found that the pair of storage tanks 30, each having a five (5) gallon capacity, wherein the first fluid 44 occupies between 60 and 80 percent of the inner space is sufficient to generate electric energy to power most automobiles.

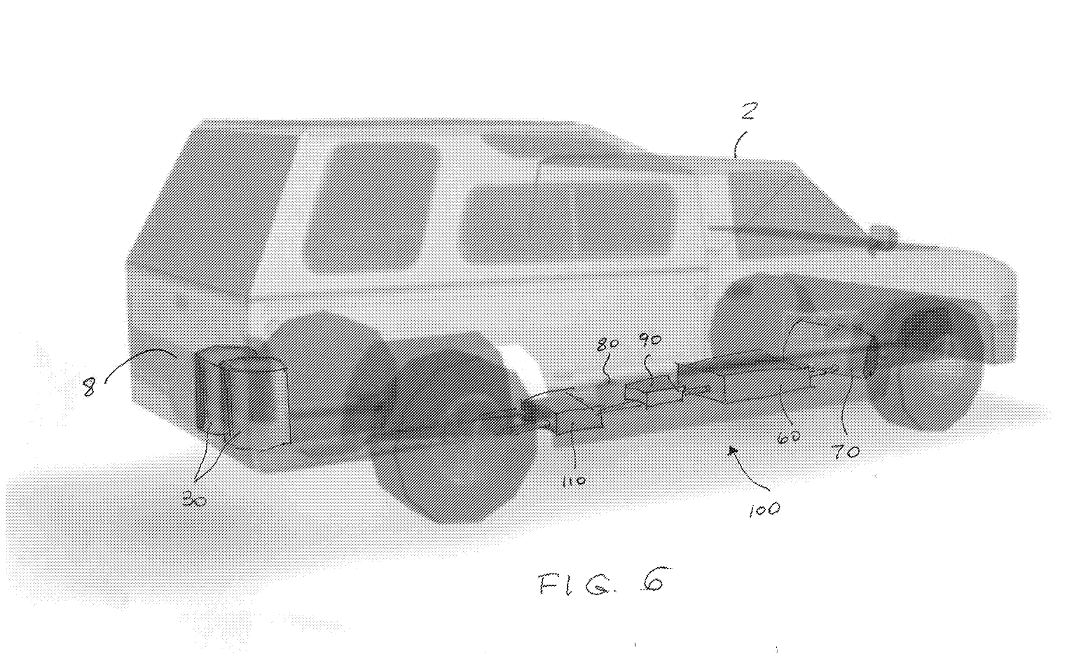

The present invention also contemplates that the connection between the outlet 74 from the reservoir 70 and the pump 80 may be directed first through separate branch within the electric generator 60, as best shown in FIG. 5, so as to maximize use of the fluid pressure and thus increase generation of the electric energy.

Although the present invention has been shown in terms of the electric energy generating system in combination with the automobile, it will be apparent to those skilled in the art, that the present invention may be applied for generating electric energy for a residential or commercial dwelling by varying the size of the components.

It is also within the scope of the present invention to integrate the functionality provided by the controller 90 into the control system of the vehicle 2 wherein the system 20 or 100 is operable for example when the starting system of the vehicle 2 is activated.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A system for converting fluid pressure into electric energy, said system comprising:
(a) at least one storage tank having each of a flexible diaphragm attached to an inner surface thereof and forming each of a first and second sealed chamber, a first fluid stored under a first pressure in said first chamber, a second fluid stored under a second pressure in said second chamber, a first port for at least dispensing said first fluid under pressure from said second fluid, a second port for filling said second chamber with said second fluid and a third port for returning said first fluid into said first chamber;
(b) a valve secured to said at least one storage tank in operable alignment with said second port thereof;
(c) a conduit connecting said first port of said at least one storage tank to said third port thereof;
(d) a flow rate control valve interposed within said conduit in series with said first port, said flow rate control valve operable to modulate flow of said first fluid in proportion to received input current;
(e) at least one electric generator interposed within said conduit and operable by said first fluid under pressure to generate electric energy;
(f) a reservoir interposed within said conduit in series with said at least one electric generator; and
(g) a fluid pump interposed within said conduit mediate said reservoir and said third port of said at least one storage tank.

2. The system, according to claim 1, wherein said system includes a controller electrically connected to each of said fluid pump and said flow rate control valve, said controller providing said input current.

3. The system, according to claim 1, wherein said system includes a battery and wherein each of said fluid pump and said flow rate control valve is electrically connected to said battery.

4. The system, according to claim 1, wherein said system further includes an ON/OFF valve coupled intermediate said first port of said at least one storage tank and said inlet port of said flow rate control valve.

5. The system, according to claim 1, wherein said at least one storage tank is a pair of juxtaposed storage tanks and wherein said system further includes an electrically operable flow direction control valve having each of a first inlet port connected, in fluid communication, to one of said pair of storage tanks, a second inlet port connected, in said fluid communication, to an opposed one of said pair of storage tanks, a third inlet port and an outlet port, connected in said fluid communication to said flow rate control valve.

6. A system for converting fluid pressure into electric energy, said system comprising:
(a) a pair of storage tanks, of said pair of storage tanks having each of a flexible diaphragm attached to an inner surface thereof and forming each of a first and second sealed chamber, a first fluid stored under a first pressure in said first chamber, a second fluid stored under a second pressure in said second chamber, a first port for at least dispensing said first fluid under pressure from said second fluid, and a second port for filling said second chamber with said second fluid;
(b) a pair of valves, each of said pair of valves secured to a respective storage tank in operable alignment with said second port thereof;
(c) a flow direction control valve having each of a first inlet port connected to one of said pair of storage tanks, a second inlet port connected to an opposed one of said pair of storage tanks, a third inlet port and an outlet port;
(d) a conduit connecting said outlet port of said flow direction control valve to said third inlet port thereof;
(e) a flow rate control valve interposed within said conduit in series with said flow direction control valve and operable to modulate flow of said first fluid in proportion to received input current;
(f) at least one electric generator interposed within said conduit and operable by said first fluid under pressure to generate electric energy;
(g) a reservoir interposed within said conduit in series with said at least one electric generator;
(h) a fluid pump interposed within said conduit mediate said reservoir and said third inlet port of said flow direction control valve;
(i) a controller electrically connected to each of said pump, said flow rate control valve and said flow direction control valve; and
(j) a battery.

7. The system, according to claim 6, wherein said system further includes a pair of ON/OFF valves, each of said pair of ON/OFF valves coupled intermediate a respective first port of said each storage tank and said inlet port of said flow direction control valve.

8. The system, according to claim 6, wherein said at least one tank is positioned upright and wherein said second chamber is disposed above said first chamber.

9. The system, according to claim 6, wherein said first fluid is a hydraulic fluid.

10. The system, according to claim 6, wherein said second fluid is air.

11. The system, according to claim 6, wherein said system includes a vehicle and wherein said at least one electric generator has at least one electrical connection with a drive system of said vehicle.

12. The system, according to claim 6, wherein said at least one electric generator is a predetermined plurality of electric generators disposed in series with each other.

13. The system, according to claim 6, wherein said at least one electric generator is a predetermined plurality of branches, each of said predetermined plurality of branches having a predetermined plurality of electric generators disposed in series with each other.

14. A method of converting fluid pressure into electric energy, said method comprising the steps of:
(a) providing a storage tank having each of a flexible diaphragm attached to an inner surface of said storage tank for dividing said at least one storage tank into each of a first and second sealed chamber, a first port in communication with said first chamber and a second port in communication with said second chamber;
(b) filling said second chamber with air to a first predetermined pressure;
(c) filling said first chamber with fluid to a second predetermined pressure;
(d) connecting, in fluid communication, an electrically operable flow rate control valve to said first port;
(e) connecting, in said fluid communication, at least one electric generator to said electrically operable flow rate control valve;
(f) connecting, in said fluid communication, a reservoir to said at least one electric generator;
(g) connecting, in said fluid communication, a fluid pump to said reservoir;
(h) connecting, in said fluid communication, said fluid pump to said storage tank;
(i) dispensing said first fluid under pressure from said first chamber;
(j) converting, at said at least one electric generator, mechanical energy from said first fluid under pressure into said electric energy;
(k) temporarily storing said first fluid in said reservoir; and
(l) activating said pump to return said first fluid into said first chamber.

15. The method, according to claim 14, wherein said step of dispensing said first fluid under pressure includes the step of activating, by an input current, said flow rate control valve.

16. The method, according to claim 14, wherein said step of dispensing said first fluid under pressure includes the step of varying a flow rate of said first fluid proportional to an input current received by said flow rate control valve.

17. The method, according to claim 14, wherein said method includes the additional steps of providing a controller and the step of electrically connecting said controller to each of said fluid pump and said flow rate control valve.

18. The method, according to claim 14, wherein said method includes the additional steps of providing a battery and electrically connecting each of said fluid pump and said flow rate control valve thereto.

19. The method, according to claim 14, wherein said method includes the additional steps of:
(a) providing a second storage tank;
(b) positioning an electrically operable flow direction control valve in a fluid return path from said fluid pump;
(c) interconnecting, in fluid communication, said flow direction control valve between said first port of each of said first and second storage tank and said flow rate control valve; and
(d) alternating flow of said first fluid from said first and second storage tanks to said at least one electric generator
